(19) United States
(12) Patent Application Publication
(10) Pub. No.: US 2014/0314411 A1
(43) Pub. Date: Oct. 23, 2014

(54) OPTICAL NYQUIST SUPERCHANNEL GENERATION USING MICROWAVE LOW-PASS FILTERING AND OPTICAL EQUALIZATION

(71) Applicant: NEC Laboratories America, Inc., Princeton, NJ (US)

(72) Inventors: Yue-Kai HUANG, PRINCETON, NJ (US); Shaoliang ZHANG, PLAINSBORO, NJ (US); Fatih YAMAN, MONMOUTH JUNCTION, NJ (US); Dayou QIAN, PRINCETON, NJ (US)

(73) Assignee: NEC Laboratories America, Inc., Princeton, NJ (US)

(21) Appl. No.: 14/218,857

(22) Filed: Mar. 18, 2014

Related U.S. Application Data
(60) Provisional application No. 61/802,795, filed on Mar. 18, 2013.

(51) Int. Cl. H04J 14/06

(52) U.S. Cl. CPC H04J 14/06
USPC 398/65

(57) ABSTRACT

Disclosed are structures and methods for generating a Nyquist superchannel.

### CROSS REFERENCE TO RELATED APPLICATIONS

This application claims the benefit of U.S. Provisional Patent Application Ser. No. 61/802,795 filed Mar. 18, 2013 for all purposes as if set forth at length herein.

### TECHNICAL FIELD

This disclosure relates generally to the field of optical communications and in particular to optical Nyquist superchannel generation using microwave low pass filtering and optical equalization.

### BACKGROUND

Optical superchannel is an emerging technology that supports optical transport data rates in excess of 100-Gb/s by combining multiple optical subcarriers to create a composite optical signal exhibiting a desired capacity. Advantageously, optical superchannel technologies may provide increased capacity sufficient to support the ever-increasing video and mobile traffic demands imposed on the Internet. Accordingly, methods, systems or structures that facilitate the development and/or deployment of optical superchannel technologies would represent a welcome addition to the art.

### SUMMARY

An advance in the art is made according to an aspect of the present disclosure directed to a method and structures for generating an optical Nyquist superchannel utilizing microwave low pass filtering and optical equalization. According to one aspect of the present disclosure, a method of generating a Nyquist superchannel output signal comprises the steps of: filtering an electrical baseband signal with finite rise-time symbols by high-order microwave low pass filter (LPF) such that the baseband signal energy is confined to a small fraction above a Nyquist rate; upconverting the filtered signal to optical frequencies by applying the filtered signal to and driving an optical modulator substantially in its linear region; demultiplexing a multi-tone optical signal and applying a demultiplexed output to the optical modulator; passively coupling an output from the optical modulator to other outputs from other modulators such that multiple subcarriers are multiplexed at a spacing above their Nyquist bandwidth; and optically equalizing the coupled multiple subcarriers such that the Nyquist superchannel is generated.

Viewed from another aspect, a method according to the present disclosure performs Nyquist shaping on standard QAM signals with a NRZ waveform at both baseband and optical frequencies. In particular microwave LPFs are utilized at baseband to confine signal energy close to the Nyquist rate. Multiple filtered baseband signals are used to modulate laser(s) to generate optical PDM QAM signal. Modulator drive voltage swing is adjusted to limit operation in a linear region and optical subcarriers are separately modulated and passively combined at a spacing slightly above Nyquist bandwidth to form optical Nyquist superchannel. The signal so generated is optically equalized to improve OSNR sensitivity and advantageously is performed with a single optical equalization device with repetitive transmission profile such that Nyquist shaping is performed on multiple subcarriers. Finally, Fabry-Perot etalon-based deviced are used to generate repetitive OEQ profile for fixed operation or LCoS based optical shaping modules may be employed to generate OEQ profile with flexible wavelength operation.

### BRIEF DESCRIPTION OF THE DRAWING

A more complete understanding of the present disclosure may be realized by reference to the accompanying drawing in which:

FIG. 1 depicts a schematic block diagram depicting the generation of a Nyquist superchannel according to an aspect of the present disclosure;

FIGS. 2(a)-2(b) depicts graphs of (a): intensity vs. wavelength of the filtering performed at Nyquist bandwidth by the microwave LPFs have achieved very steep signal edge roll-offs; and (b) intensity vs. wavelength of a three-subcarrier Nyquist superchannel after OEQ is applied using an LCoS optical shaping module according to an aspect of the present disclosure; and

FIG. 3 depicts a graph showing a back-to-back bit-error-rate vs. signal OSNR measurement according to an aspect of the present disclosure;

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we begin by noting that optical superchannel is a promising technology for increasing fiber channel capacity in next generation optical networks, i.e. 400 Gb/s or 1 Tb/s per channel. As may be readily appreciated, by “packing” multiple subcarriers into a tighter spacing, optical superchannel can dramatically improve spectral efficiency of the transmission without increasing signal constellation advantageously avoiding high transmission penalties.

Nyquist optical superchannel, as its name suggests, allows the subcarriers within the superchannel to be multiplexed at a frequency spacing equal to or slightly larger than the individual subcarrier baud-rate, thereby enabling “Nyquist-rate” transmission.

In order to avoid any crosstalk between subcarriers, pulse shaping techniques are required to confine signal energy of each subcarrier to a certain bandwidth equal to, or slightly higher than its signal baud-rate. To achieve the best transmission performance in terms of receiver OSNR sensitivity and fiber nonlinearity tolerance, it is desirable to produce a flat-top subcarrier signal spectrum. As may be readily appreciated, a rectangular shaped signal spectrum will exhibit a broader impulse response (ideally sine pulses) in the time domain which can be recovered by an adaptive time delay estimator (TDE) in the receiver DSP.

As is known, the so called “Nyquist” pulse shaping may be performed either digitally or optically. In the case of digital pulse shaping, digital generated data are either convoluted with a sine pulse function, or passed through a sharp rectangular low-pass filter (LPF), such that the signal spectrum is confined while maintaining orthogonality of neighboring symbols in time domain. As may be readily understood, Nyquist-shaped signal(s) cannot be used for optical signal modulation without digital-to-analog converters (DAC). For fiber channel capacity beyond 100 Gb/s requiring Nyquist bandwidth above 16 GHz, it is difficult and costly to design and build a DAC with such high-speed characteristics.

Another pulse shaping method involves “quasi-Nyquist” shaping in the optical domain. With this quasi-Nyquist pulse shaping method, the signal is first generated by driving optical modulators with rectangular waveforms exhibiting a finite rise and fall time, and producing optical bandwidth much larger than the Nyquist bandwidth (equivalent to the signal baud-rate). The generated signal is then optically filtered thereby reducing the signal bandwidth before multiple subcarriers are multiplexed thereby avoiding large cross-talk in reduced subcarrier spacing.

Optical equalization may then be applied to the multiplexed subcarriers using a pre-defined optical profile, in which the maximum transmittance is at the edge of each subcarrier, and the center region of each subcarrier is attenuated such that a more flattened spectrum is produced thereby increasing the receiver OSNR sensitivity. As may be understood, the optical filtering and equalization may be performed using fixed optical components such fiber Bragg gratings (FBGs) and Faby-Perot (FP) etalons. To add flexibility, programmable liquid-crystal-on-silicon (LCoS) based optical wave-shaping modules may be employed—along with their much higher cost. Even with these techniques, contemporary optical filtering technology does not provide enough resolution to produce a sharp roll-off at signal band edge to sufficiently eliminate crosstalk between adjacent subcarriers.

With this additional background in place we note that—according to the present disclosure—by performing the Nyquist shaping process in two steps, one in a baseband frequency and one in an optical frequency, our method according to the present disclosure presents several advantages over prior-art methods. First, it is easier to obtain a high-order filter response exhibiting sharp filter edges using microwave filters in the baseband frequencies (compare to optical filtering). Consequently, better performance is achieved by reducing any cross-talk between subcarriers. Secondly—since the filtering is done in the baseband—there is little risk of chopping off too much signal energy due to signal/filter frequency mismatch that could be caused—for example—by laser drifting.

Notably—and as compared to the implementations of digital Nyquist shaping—methods according to the present disclosure do not require high-speed DACs for signal generation—thereby dramatically reducing the system complexity and cost. Finally, optical equalization (OEQ) can be performed on multiple subcarriers or even multiple superchannels using only one single optical device with repetitive profile thereby reducing implementation cost even further.

As may be appreciated by those skilled in the art, by separating Nyquist shaping into two steps, one in baseband filtering and another in optical equalization, methods according to the present disclosure achieve better performance as compared to doing it all optically. Moreover, the cost of implementing these two steps separately relaxes the requirements quite significantly for generating Nyquist subcarriers with large data rate. For example, to generate subcarriers using digital Nyquist shaping with larger than 100-Gb/s data rate, high speed DAC with sampling rate larger than 30 GSa/s is required. As compared to both purely digital Nyquist shaping or optical Nyquist shaping, methods according to the present disclosure may be applied to current standard transmission technologies with Non-Return-To-Zero (NRZ) waveforms to obtain similar or better performance with much lower cost and complexity.

More specifically, a number of distinct aspects and advantages of methods according to the present disclosure become apparent. In particular, i) (a) Using microwave LPF instead of optical filtering or digital filtering to either improve performance or reduce implementation cost and complexity; and (b) using single OEQ devices to perform Nyquist shaping over multiple subcarriers reduce the cost significantly; and ii) the adjustment of the modulator drive voltage is crucial in maintaining the linear signal up-conversion to optical frequencies without signal distortion. As may be readily appreciated, this step is different than standard modulation method where standard NRZ waveforms are used

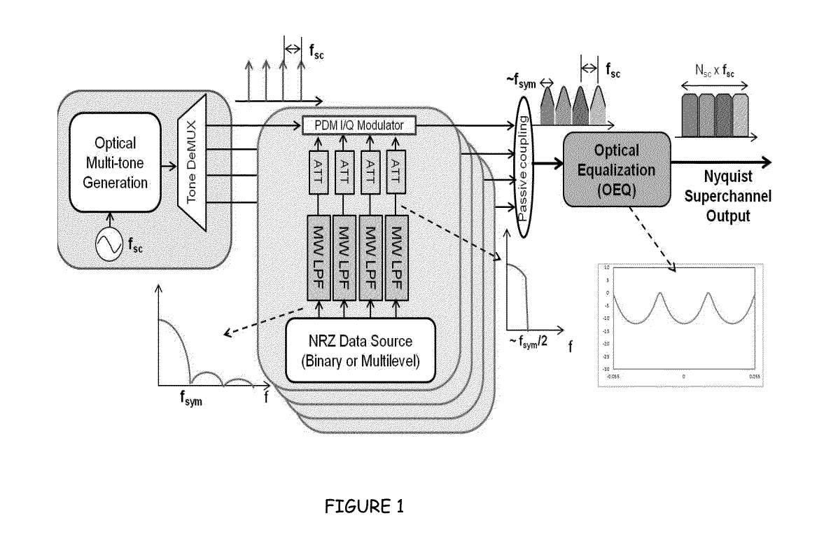

Turning now to FIG. 1, there it shows a schematic block diagram of the generation a of Nyquist superchannel according to an aspect of the present disclosure. As depicted in that FIG. 1, the process begins with the generation of multiple optical tones. The tones, exhibit a free spectral range (FSR) of f_{sc} which represents the spacing between subcarriers, advantageously can be optical combs generated by a fundamentally mode-locked laser, a gain switched laser, or through wide-band phase modulation.

An optical demultiplexer (Tone DeMUX) is then used to separate each optical tone for individual subcarrier modulation. As may be understood, if f_{sc} is large as compared to the range of laser frequency drifting, than separate lasers can also be used for subcarrier modulation.

For each subcarrier—assuming that quadrature amplitude modulation (QAM) is used on both polarizations, a total of four electrical data signals will be generated. These signals can be standard, non-return-to-zero (NRZ) binary waveforms for DP-QPSK modulation, or rectangular, multi-level waveforms for high-order QAM modulation such as 16-QAM or 64-QAM. A NRZ signal waveform will exhibit frequency null at f_{sym} (the modulation symbol rate) and several high frequency side-lobes.

The first step of Nyquist shaping according to the present disclosure is to apply the four signal lanes through four separate microwave LPFs (MWLPF) each exhibiting a cut-off frequency slightly above f_{sym/2} (less than 10%) to remove the frequency contents above the Nyquist bandwidth, as shown in the inset in FIG. 1.

Advantageously, commercial microwave LPFs having a high-order filter design are readily available to p r o du c e a sharp frequency roll-off that is required. The four LPF outputs are then applied to and used to drive four ports of a polarization division multiplexed (PDM) in-phase and quadrature (I/Q) modulator to up-covert the baseband QAM signal to optical frequency in two polarizations.

Notably, and instead of driving the modulator port(s) at a full range V_{D} like standard NRZ waveforms, appropriate measures must be taken such that only a linear region of the optical modulator is used thereby avoiding signal distortion. Therefore appropriately valued electrical attenuators (ATT) must be inserted between the LPFs and the PDM I/Q Modulator. The resulting PDM QAM modulated subcarriers output by the PDM I/Q Modulator are combined using—for example—passive optical couplers.

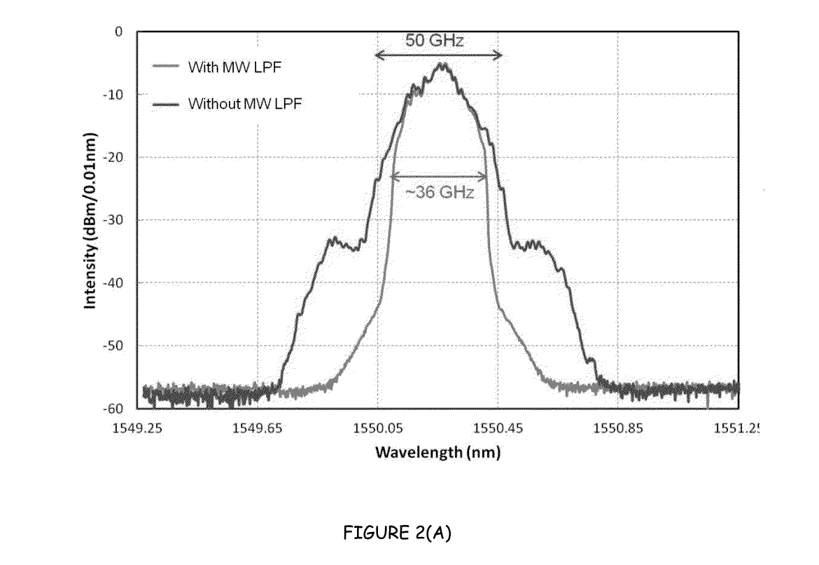

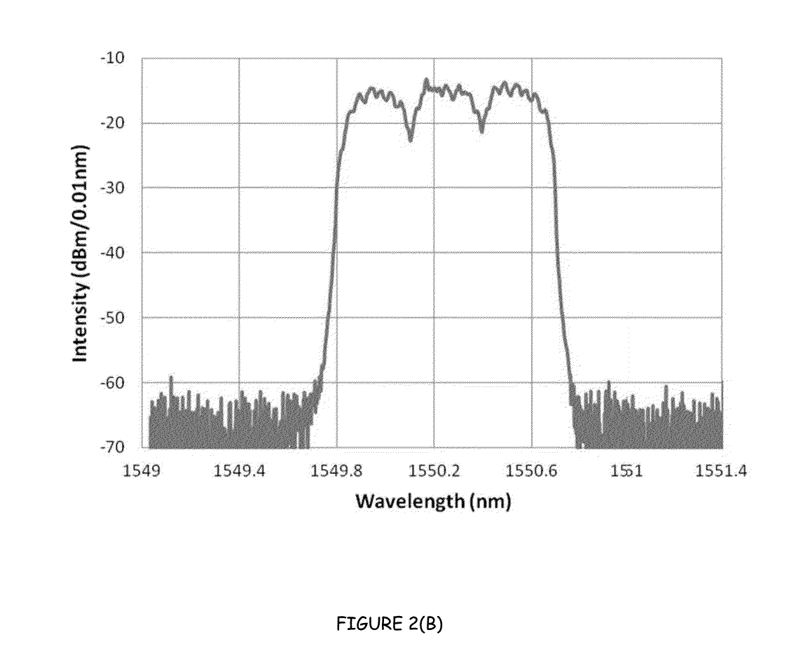

As shown graphically in FIG. 2(a), filtering performed at Nyquist bandwidth by the microwave LPFs have achieved very steep signal edge roll-offs, which advantageously will achieve better performance than optical filtering when cross-talk between subcarriers is considered. In the example depicted in FIG. 2(a), a standard 127-Gb/s DP-QPSK signal, which normally requires 50-GHz in DWDM transmission, can be confined to about 36-GHz wide, roughly 13% above the Nyquist bandwidth.

Returning to our discussion of FIG. 1, it is noted that a second step of Nyquist shaping according to the present disclosure may advantageously be performed over the whole superchannel after subcarrier multiplexing using one single optical equalization (OEQ) module which may advantageously be based upon—for example—FP etalon or LCoS technologies. Preferably, the OEQmodule exhibits a repetitive transmission profile, in which the maximum transmittance is at an edge of each subcarrier as shown in FIG. 1 inset, and a center region of each subcarrier is attenuated.

As may be appreciated, the output spectrum of the superchannel exhibits a much more uniformed energy distribution across its occupied band. This uniform spectral distribution advantageously improves receiver OSNR sensitivity since the ratio between the transmitted signal and noise can be maintained for both low and high frequency contents. An example, consider the graph shown in FIG. 2(b). There it graphically demonstrates a three-subcarrier Nyquist superchannel after OEQ is applied using an LCoS optical shaping module. Nyquist shaping creates long impulse responses as compared to NRZ waveforms. Using adaptive time-domain equalizers (TOE) with adequate tap length, which are already implemented for compensating other fiber impairments, the impulse response can be handled by the receiver DSP without incurring penalty.

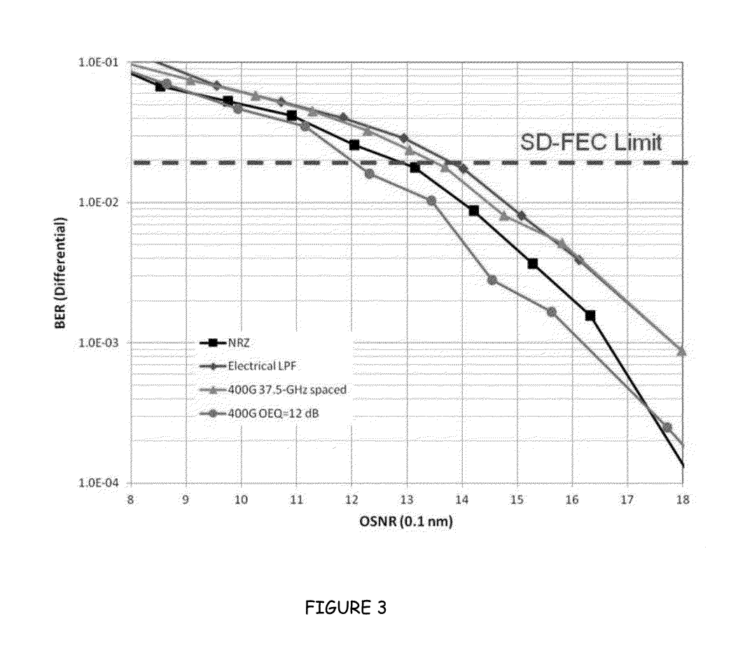

Finally, FIG. 3 graphically shows a back-to-backbit-error-rate vs. signal OSNR measurement. At a soft-decision forward error correction (SD-FEC) limit—which is the maximum error rate before decoding to maintain error-free transmission—adding the microwave LPF, the first step of the Nyquist shaping, only degrades the performance of the 128-Gb/s DP-QPSK subcarrier by about 0.5 dB. (Alternatively stated, one needs 0.5 dB more OSNR to achieve the same performance). However, because of the sharp filtering created by the microwave filters, the subcarriers can be multiplexed at 37.5-GHz spacing for 400G transmission, only 17% higher than Nyquist rate, without incurring any more penalties from cross-talk. After performing OEQ—the second step of Nyquist shaping—the OSNR performance improves significantly—about 1-dB better—than the original NRZ signal.

At this point, the foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method of generating a Nyquist superchannel output signal comprising the steps of:
filtering an electrical baseband signal with finite rise-time symbols by high-order microwave low pass filter (LPF) such that the baseband signal energy is confined to a small fraction above a Nyquist rate;
upconverting the filtered signal to optical frequencies by applying the filtered signal to and driving an optical modulator substantially in its linear region;
demultiplexing a multi-tone optical signal and applying a demultiplexed output to the optical modulator;
passively coupling an output from the optical modulator to other outputs from other modulators such that multiple subcarriers are multiplexed at a spacing above their Nyquist bandwidth; and
optically equalizing the coupled multiple subcarriers such that the Nyquist superchannel is generated.
